(19) United States
(12) Patent Application Publication
(10) Pub. No.: US 2025/0237313 A1
(43) Pub. Date: Jul. 24, 2025

(54) AIR VENT FOR A WHEEL HUB ASSEMBLY

(71) Applicant: Consolidated Metco, Inc., Vancouver, WA (US)

(72) Inventors: Gregg Smith, Vancouver, WA (US); Max Gettles, Ridgefield, WA (US); Connor Regan, Vancouver, WA (US); Mark Leineweber, Portland, OR (US); Karthik Prakash Sivakumar, Vancouver, WA (US)

(21) Appl. No.: 19/036,573

(22) Filed: Jan. 24, 2025

Related U.S. Application Data
(60) Provisional application No. 63/624,670, filed on Jan. 24, 2024.

(51) Int. Cl. F16K 15/20; B60B 27/00; B60B 27/02; F16K 17/36

(52) U.S. Cl. CPC F16K 15/20; B60B 27/0047; B60B 27/02; F16K 17/366; B60B 2900/211; B60B 2900/561

(57) ABSTRACT

In one aspect, a wheel hub assembly including a wheel hub body having an interior, bearing assemblies to rotatably connect the wheel hub body to a spindle, and a vent associated with the wheel hub body that opens to the interior of the wheel hub body. The wheel hub assembly further includes an inertia-controlled valve of the vent rotatable with the wheel hub body. The inertia-controlled valve is configured to open in response to rotation of the inertia-controlled valve with the wheel hub body and permit air to flow out of the interior of the wheel hub body.

### CROSS-REFERENCE TO RELATED APPLICATION

This application claims the benefit of U.S. Provisional Application No. 63/624,670 filed Jan. 24, 2024, which is incorporated herein by reference in its entirety.

### TECHNICAL FIELD

This disclosure relates to wheel hub assemblies for vehicles and, more particularly, to wheel hub assemblies having air vents.

### BACKGROUND

Wheel hub assemblies are used to connect wheels to axles of vehicles. For example, a wheel hub assembly may be mounted on a spindle of a vehicle axle to provide a rotatable mounting surface on which to mount a wheel and tire assembly. Many different types of wheel hub assemblies are available for a myriad of different vehicle applications. For example, various types of wheel hub configurations are available for heavy-duty trucks depending upon whether the wheel is a steer wheel, driven wheel, trailer wheel, or tandem wheel.

Some axles are drive axles, which include spindles at the ends of the axle and semi-shafts in the spindles. Wheel hub assemblies used with drive axles include a wheel hub and bearing assemblies to rotatably mount the wheel hub to the spindle. The semi-shaft has a drive flange connected to an outboard end of the wheel hub such that rotation of the semi-shaft causes rotation of the wheel hub.

Wheel hub assemblies typically contain a lubricant, such as oil, for lubricating the bearing assemblies of the wheel hub assemblies. In some vehicles, the bearing assemblies of the wheel hub assemblies are in fluid communication with an interior of the associated axle such that lubricant may travel between the bearing assemblies and the interior of the axle. The lubricant may thereby lubricate both the bearings of the wheel hub assemblies and components in the interior of the axle such as a differential.

Some wheel hub assemblies are sealed to retain lubricant in the wheel hub assembly. One shortcoming with these systems is that the pressure in the wheel hub assembly may increase as the wheel hub is rotated, for example, due to an increase in temperature and/or the seal pumping air into the wheel hub assembly. High air pressure in the wheel hub can lead to premature seal failures, for example, failure of a dynamic seal on the inboard side of the wheel hub.

### BRIEF DESCRIPTION OF DRAWINGS

FIG. 1 is a perspective view of a wheel hub assembly of a drive axle of a vehicle.

FIG. 2A is a cross-sectional view of the wheel hub assembly taken along line 2A-2A of FIG. 1 when the vehicle is in motion, FIG. 2A showing a fill plug vent of the wheel hub assembly extending into an interior of the wheel hub assembly while oil in the wheel hub is flung against a radially inner surface of an internal cavity of the wheel hub assembly.

FIG. 2B is an enlarged view of the region indicated by a dashed box in FIG. 2A showing an inlet of the fill plug vent spaced from the oil held against the radially inner surface of the internal cavity by centrifugal force.

FIG. 3 is a perspective view of the fill plug vent of FIG. 1.

FIG. 4 is an exploded view of the fill plug vent of FIG. 3.

FIG. 5A is a cross-sectional view of the fill plug vent of FIG. 3 taken along line 5A-5A of FIG. 3, FIG. 5A showing the fill plug vent in a closed configuration which inhibits lubricant from exiting the interior of the wheel hub assembly via the fill plug vent.

FIG. 5B is a cross-sectional view similar to FIG. 5A showing the fill plug vent in an open configuration that permits air to exit the interior of the wheel hub assembly via the fill plug vent.

FIG. 6 is a cross-sectional view of a fill plug vent according to another embodiment having a vent portion attached to a single piece outer body.

FIG. 7 is a cross-sectional view of a fill plug vent according to another embodiment, the fill plug vent including a single piece housing.

### DETAILED DESCRIPTION

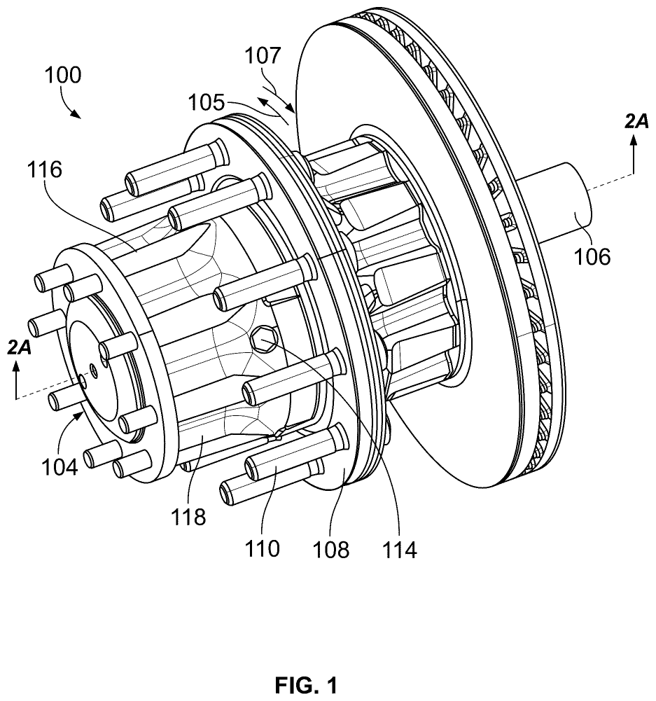

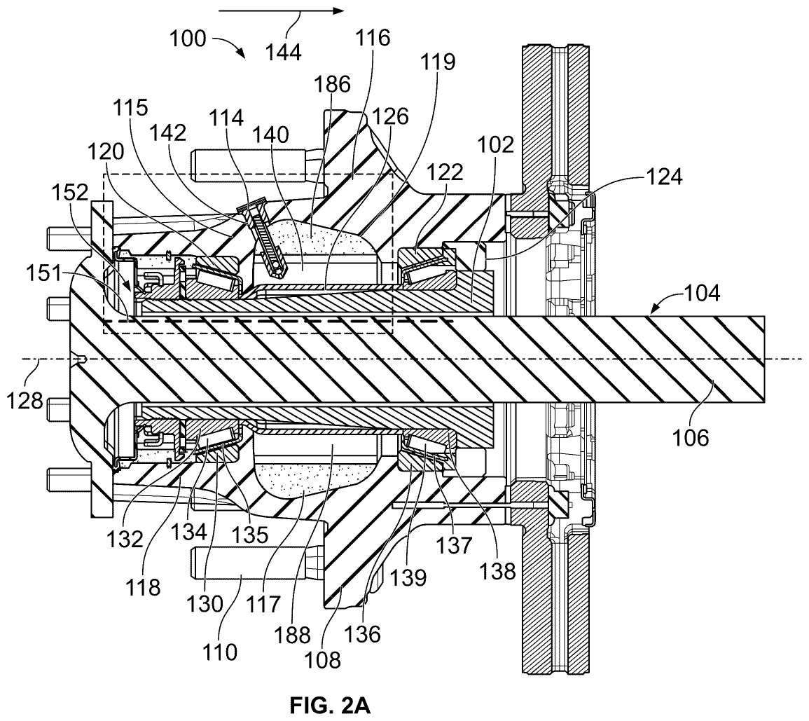

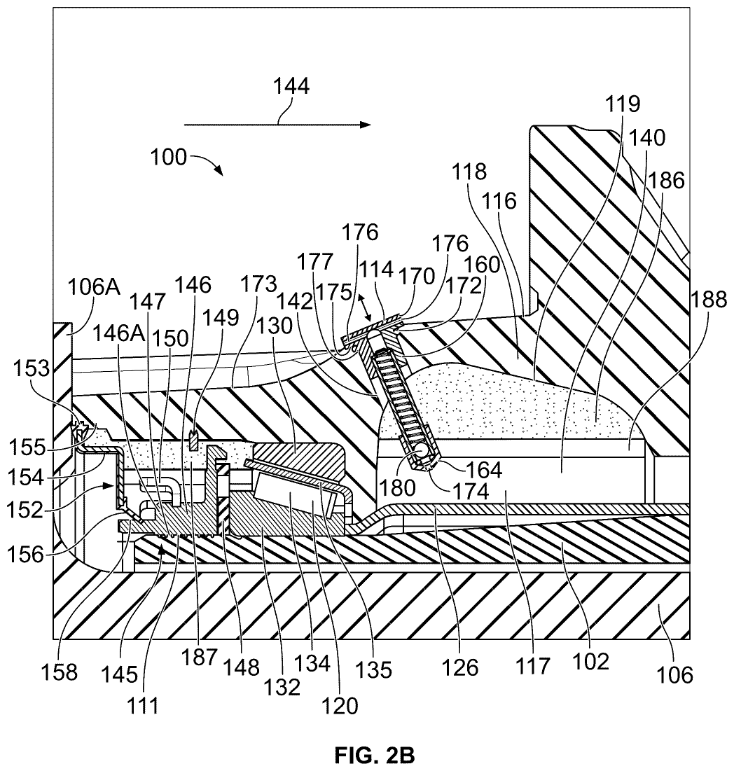

With respect to FIGS. 1-2A, a wheel hub assembly 100 is shown mounted to a spindle 102 of a drive axle 104 of a vehicle. The wheel hub assembly 100 is rotatable about the spindle 102 in directions 105, 107 (see FIG. 1). The wheel hub assembly 100 includes a wheel hub 116 having a hub body 118 with a lubricant fill opening such as port 142 (see FIG. 2A) formed in an annular side wall 115 of the hub body 118. The port 142 opens to an interior 117 of the hub body 118 that includes a grease pocket 140. The port 142 permits lubricant, such as oil, to be added to or removed from the interior 117 of the hub body 118.

The wheel hub assembly 100 includes an air vent, such as a fill plug vent 114, installed in the port 142. The fill plug vent 114 rotates with the hub body 118 as the hub body 118 rotates around the spindle 102. The fill plug vent 114 has a closed configuration that inhibits the oil in the grease pocket 140 from exiting the grease pocket 140. Upon the vehicle accelerating to a predetermined speed, such as 45 miles per hour, the fill plug vent 114 shifts automatically and without user intervention to an open configuration wherein the fill plug vent 114 permits air to exit the interior 117 and equalize the pressure of air in the interior 117 with the ambient air pressure. The fill plug vent 114 may be unthreaded or otherwise disconnected from the port 142 to permit the interior 117 of the wheel hub 116 to be filled with oil or drained.

Regarding FIG. 2A, the drive axle 104 includes a semi-shaft 106 that extends through the spindle 102. The wheel hub 116 has a mounting flange 108 of the hub body 118 and studs 110 protruding from the mounting flange 108 for mounting a wheel thereto. The wheel hub assembly 100 further includes an outboard bearing assembly 120, an inboard bearing assembly 122, an inboard seal 124, an outboard seal 152, and a spacer 126. The spacer 126 is configured to maintain a predetermined axial distance between the outboard and inboard bearing assemblies 120, 122. The hub body 118 may have a unitary, one-piece construction and may be made of a metallic material such as steel, iron, or aluminum as some examples. The outboard and inboard bearing assemblies 120, 122 permit the hub body 118 to rotate on the spindle 102 around a central axis 128 (see FIG. 2A).

The outboard bearing assembly 120 includes an outer race such as an outboard bearing cup 130, an inner race such as the outboard bearing cone 132, bearings such as roller bearings 134, and a bearing cage 135 to hold the roller bearings 134. The inboard bearing assembly 122 includes an outer race such as an inboard bearing cup 136, an inner race such as the inboard bearing cone 138, bearings such as roller bearings 139, and a bearing cage 137 to hold the roller bearings 139.

Regarding FIG. 2A, when the wheel hub assembly 100 is filled with oil and the vehicle is stationary, the oil may fill the interior 117 to an approximate level shown by the dashed line 151. The term filled with oil as used herein is intended to encompass a volume that permits normal operation of the components of the wheel hub assembly 100 to be lubricated. Upon movement of the vehicle and rotation of the wheel hub 116, oil in the interior 117 of the hub body 118 spreads evenly along an interior surface 119 of the interior 117 and flows between the inboard seal 124 and the outboard seal 152 to lubricate the outboard and inboard bearing assemblies 120, 122.

Regarding FIGS. 2A and 2B, the wheel hub assembly 100 is mounted on the spindle 102 by advancing the wheel hub 116 in inboard direction 144 along the spindle 102. The outboard and inboard bearing assemblies 120, 122 and spacer 126 have central openings that receive the spindle 102. The wheel hub assembly 100 includes a spindle nut assembly 145 having a spindle nut 146 to secure the wheel hub assembly 100 to the spindle 102. The spindle nut 146 includes inner threads 147 that engage outer threads 111 of the spindle 102. The spindle nut 146 has a drive head portion 146A that is used to rotate the spindle nut 146 to secure the wheel hub 116 to the vehicle. The drive head portion 146A may have a rotary drive structure, such as a hexagonal portion, configured to permit a wrench or socket to be used to turn the spindle nut 146. The spindle nut assembly 145 may further include a locking washer 148, a spiral locking ring 149, and a locking ring 150 for securing the spindle nut 146 to the spindle 102 and inhibiting the spindle nut 146 from rotating relative to the spindle 102 (e.g., unintentionally loosening or unthreading). The locking washer 148 includes a tab that extends into a keyway of the spindle 102 to inhibit rotation of the locking washer 148 relative to the spindle 102. The locking ring 150 includes a tab that extends through the spindle nut 146 and the locking washer 148 to secure the spindle nut 146 to the locking washer 148 and inhibit the spindle nut 146 from rotating relative to the locking washer 148 and the spindle 102 (e.g., unthreading from the spindle 102).

The outboard seal 152 inhibits lubricant from flowing between the grease pocket 140 and the interior of the axle. The outboard seal 152 may take a variety of forms such as those disclosed in U.S. patent application Ser. No. 18/166,727, filed Feb. 9, 2023 and Ser. No. 18/212,436, filed Jun. 21, 2023, which are hereby incorporated by reference herein. In the embodiment of FIG. 2B, the outboard seal 152 includes a seal body 154 sized to be inserted into the interior 117 of the hub body 118 and fixed thereto. At a radially outer end of the seal body 154, the outboard seal 152 includes a radially outer seal 153 that engages the interior surface 119 of the hub body 118 and may be clamped between a shoulder 155 of the hub body 118 and the drive flange 106A of the semi-shaft 106. In one embodiment, the outboard seal 152 is configured to be press-fit into the interior 117 of the hub body 118 before the drive flange 106A is secured to the hub body 118.

At a radially inner end of the seal body 154, the outboard seal 152 includes a radially inner lip sealing member 156 configured to engage a running surface 158 of the spindle nut 146 and form a dynamic seal with the running surface 158. The lip sealing member 156 is resilient and is deflected slightly when contacting the running surface 158 such that the lip sealing member 156 resiliently biases a radially inner portion of lip sealing member 156 against the running surface 158. The lip sealing member 156 rotates around the running surface 158 of the spindle nut 146 as the vehicle moves and the hub body 118 rotates due to the outboard seal 152 being fixed to the hub body 118.

The lip sealing member 156 inhibits lubricant contained in the wheel hub 116 from leaking out of the wheel hub assembly 100 and into the interior of the spindle 102. As the outboard seal 152 rotates with the wheel hub 116, the lip sealing member 156 pumps oil in an inboard direction 144 along the running surface 158 to keep the lubricant from leaking outboard beyond the lip sealing member 156. In some situations, the outboard seal 152 may pump air into the wheel hub 116 during rotation of the wheel hub 116, which can cause the air pressure in the wheel hub 116 to increase.

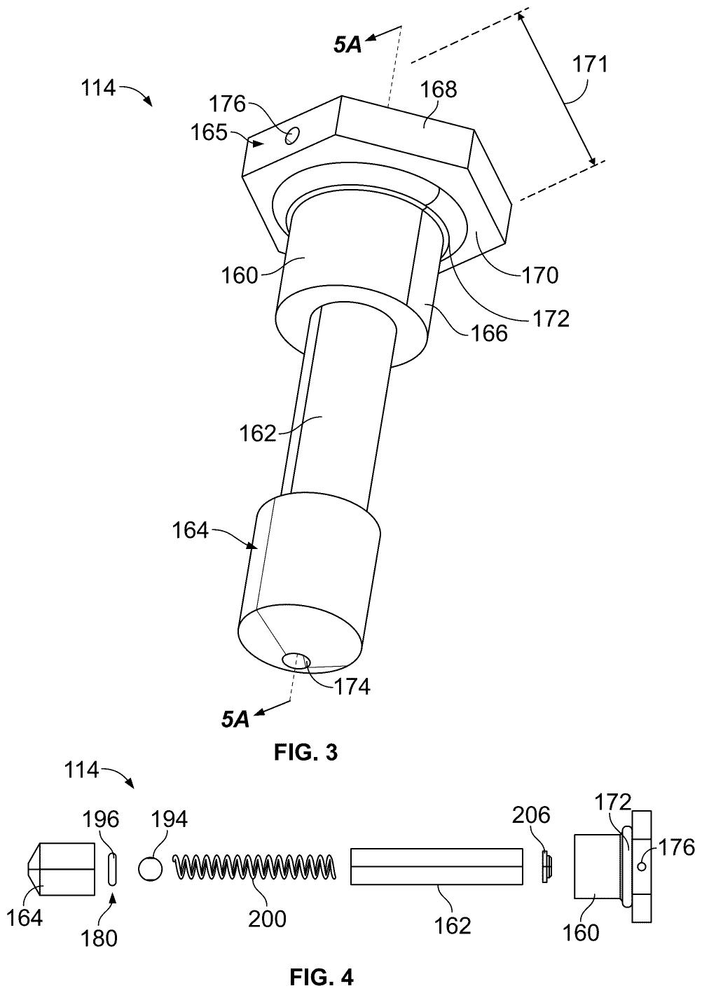

With respect to FIGS. 3-5B, the fill plug vent 114 includes a base or body 166 having a plug portion 160 and a rotary drive structure such as a drive head portion 168. The plug portion 160 is sized to obstruct the port 142 and inhibit oil from exiting the interior 117 of the hub body 118 via the port 142. The plug portion 160 has, for example, male threads for engaging female threads of the port 142 to connect the fill plug vent 114 to the wheel hub 116. The drive head portion 168 has, for example, a hex drive configuration to permit a tool such as a socket or wrench to engage the drive head portion 168 and turn the fill plug vent 114 to connect or disconnect the fill plug vent 114 from the wheel hub 116.

The drive head portion 168 has a flange 170 at an end of the body 166 of the plug portion 160. The flange 170 has a width 171 that is wider than an inner diameter of the port 142 to limit how far the fill plug vent 114 is able to be inserted into the port 142. The plug portion 160 includes a seal such as O-ring 172 to form a fluid tight seal between the fill plug vent 114 and the hub body 118.

Regarding FIG. 2B, the hub body 118 has an exterior surface 173 and the port 142 extends between the exterior surface 173 and the interior surface 119. The exterior surface 173 includes an annular, flat surface portion 175 extending around the port 142 and a recessed seating surface 177. The recessed seating surface 177 is annular and cup-shaped or otherwise tapered to have an inner diameter that decreases as the recessed seating surface 177 extends inward from the flat surface portion 175 toward the interior surface 119. As the fill plug vent 114 is threaded into the port 142, the plug portion 160 advances along the port 142 toward the interior 117 and brings the O-ring 172 (see also FIG. 3) into contact with the seating surface 177. Continued threading of the fill plug vent 114 into the port 142 continues advancing the O-ring 172 farther along the seating surface 177 and tightly engages or seats the O-ring 172 against the seating surface 177 due to the decreasing inner diameter of the seating surface 177. When the fill plug vent 114 is fully torqued, the flange 170 seats against the flat surface portion 175 to provide a hard stop for the fill plug vent 114. The O-ring 172 is positioned in the port 142 when the fill plug vent 114 has been installed, which permits the O-ring 172 to be received in the port 142 and protected from the road environment by the flange 170 engaged with the hub body 118 around the O-ring 172.

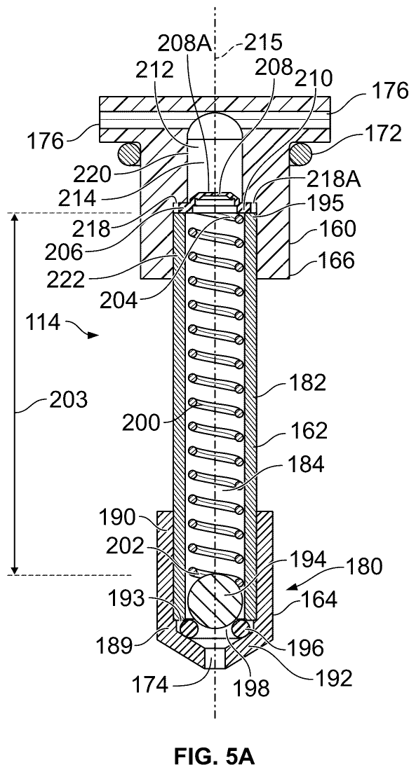

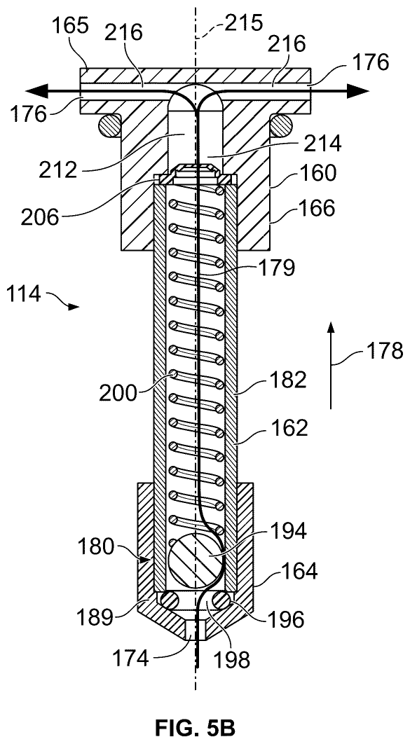

Regarding FIGS. 2B and 3, the fill plug vent 114 permits air in the interior 117 to vent from the interior of the wheel hub 116 to the exterior of the wheel hub 116. The fill plug vent 114 has an inlet portion 164 with at least one air inlet 174 and an outlet portion 165 with one or more air outlets 176. The fill plug vent 114 has a flow path 179 (see FIG. 5B) extending from the air inlet 174 to the air outlets 176 through the inlet portion 164, spacer portion 162, and plug portion 160. Air may flow in direction 178 along the flow path 179.

Regarding FIG. 5B, the fill plug vent 114 includes a valve 180 and a check valve or one-way valve 206 in the flow path 179. The valve 180 may be in the flow path 179 proximate the air inlet 174 and the one-way valve 206 may be in the flow path 179 downstream of the valve 180, for example, proximate the air outlets 176. The valve 180 has a closed configuration as shown in FIG. 5A and an open configuration as shown in FIG. 5B. When the valve 180 is in the closed configuration of FIG. 5A, oil and air in the interior 117 of the hub body 118 are inhibited from flowing from the air inlet 174 to the air outlets 176. When the valve 180 is in the open configuration of FIG. 5B, the valve 180 permits air to flow from the air inlet 174 to the air outlets 176. Venting the air from the interior 117 permits higher pressure air in the interior 117 to escape to the surrounding environment. Further, venting air from the interior 117 limits air pressure in the interior 117 from increasing beyond a predetermined level that could damage the inboard seal 124 and/or the outboard seal 152. The higher pressure air in the interior 117 may be caused by, for example, friction as the bearing assemblies 120, 122 rotate and/or the rotating sealing member 156 of the outboard seal 152 pumping air into the interior 117. Limiting air pressure build up in the interior 117 of the wheel hub 116 helps keep the outboard seal 152 and inboard seal 124 from degrading in performance and from premature failure, for example, a rupture due to air pressure build-up.

Regarding FIG. 5B, the body 166 of the fill plug vent 114 includes a passageway 212 extending through the body 166 and including the air outlets 176. The passageway 212 includes an axial portion 214 extending along a central axis 215 of the fill plug vent 114 and lateral portions 216 branching off from the axial portion 214. The axial portion 214 extends in the port 142 when the fill plug vent 114 is secured to the hub body 118. The lateral portions 216 extend outward from the axial portion 214 to the air outlets 176. Having the flow path 179 turn or bend from the axial portion 214 to the air outlets 176 provides a tortuous path that inhibits fluid and debris from entering the fill plug vent 114 through the air outlets 176 and traveling into the axial portion 214. The inner diameter of the lateral portions 216 may also be smaller than an inner diameter of the axial portion 214 to keep larger debris out of the passageway 212. The reduced inner diameter of the lateral portions 216 extending to the air outlets 176 may also increase the velocity of air flowing out of the air outlets 176 which may aid to blow or otherwise force fluid and debris in the lateral portions 216 out of the fill plug vent 114 when the valve 180 is opened. In this manner, the fill plug vent 114 is self-cleaning and uses air being vented through the fill plug vent 114 to discharge liquid and debris from the passageway 212. While the embodiment shown includes two air outlets 176, the fill plug vent 114 may have any number of air outlets, for example, one, three, four, or more air outlets 176.

Regarding FIG. 5A, the spacer portion 162 includes a body such as a tube 182 and an interior or opening 184 extending through the tube 182 and forming a portion of the flow path 179 (see FIG. 5B). Regarding FIG. 2B, the spacer portion 162 extends from the plug portion 160 and spaces the inlet portion 164 from the plug portion 160 such that when the fill plug vent 114 is mounted to the hub body 118, the spacer portion 162 positions the inlet portion 164 and air inlet 174 thereof in the grease pocket 140 and away from the interior surface 119 of the hub body 118.

When the vehicle is at rest, the oil pools at the bottom of the interior 117 due to gravity. When the vehicle begins moving, the wheel hub 116 rotates and the oil is urged radially outward against the interior surface 119 of the hub body 118 as generally shown by oil 186, 187 in FIG. 2B. The interior surface 119 applies a centripetal force against the oil 186, 187 that resists the oil 186, 187 being urged against the interior surface 119 by the rotation of the wheel hub 116. Because the oil is urged radially outward by the rotation of the wheel hub 116, a void or air pocket 188 forms in a region between the spacer 126 and the oil 186 in the grease pocket 140. The spacer portion 162 of the fill plug vent 114 supports the air inlet 174 in the region of the grease pocket 140 that becomes the air pocket 188 when the wheel hub 116 rotates above a certain speed (e.g., 10-20 miles per hour (mph)). With the air inlet 174 positioned in the air pocket 188 during movement of the vehicle, the oil is radially outward of the air inlet 174 so that air is able to enter the air inlet 174 with minimal, if any, oil entering the air inlet 174.

Regarding FIG. 5A, the inlet portion 164 in one form includes an end cap 189 having a sleeve portion 190 and a support portion 192. The sleeve portion 190 may be sized to receive an end portion of the tube 182. The support portion 192 includes the air inlet 174 to permit air to enter the fill plug vent 114. The support portion 192 may be conical and taper from the sleeve portion 190 to the air inlet 174. The support portion 192 may support a portion of the valve 180 as discussed below. The end cap 189 of the inlet portion 164 may be attached to the tube 182 of the spacer portion 162, for example, by welding or an adhesive. In other forms, the inlet portion 164 has a unitary, one-piece construction with the spacer portion 162.

The valve 180 is positioned in the flow path 179 (see FIG. 5B) of the fill plug vent 114 between the air inlet 174 and the air outlets 176. The valve 180 includes sealing portions, such as a sealing element 194 and a valve seat 196, that may be engaged with one another to inhibit fluid flow through the valve 180 or disengaged from one another to permit fluid (e.g., air) flow therethrough. In one embodiment, the sealing element 194 is a ball bearing and the valve seat 196 is an O-ring.

With reference to FIGS. 5A-5B, the sealing element 194 is shiftable relative to the valve seat 196 along the central axis 215 between a closed position (FIG. 5A) and an open position (FIG. 5B). The valve seat 196 includes an opening 198 through which fluid is able to flow. In the closed configuration, the sealing element 194 is engaged with the valve seat 196 to close the opening 198 of the valve seat 196 and inhibit fluid (air and/or oil) from flowing therethrough. In the open configuration, the sealing element 194 is disengaged with, such as spaced from, the valve seat 196 so that the sealing element 194 does not close the opening 198 and permits fluid to flow through the opening 198 of the valve seat 196. The sealing element 194 is positioned in the flow path 179 and is sized to permit fluid to flow around the sealing element 194 when disengaged with the valve seat 196. In the form shown, the sealing element 194 is spherical and has a diameter that is smaller than an inner diameter of the tube 182.

Regarding FIG. 5A, the valve seat 196 is fixed in place to inhibit the valve seat 196 from moving along the flow path 179. For example, a peripheral portion of the valve seat 196 may be sandwiched between the support portion 192 of the cap 189 and an end portion 193 of the tube 182.

The valve 180 may include a biasing member, such as spring 200, that urges the sealing element 194 toward the valve seat 196. The spring 200 may be or include a coil spring, linear spring, or air spring as some examples. In FIG. 5A, the spring 200 is a coil spring having a first end portion 202 connected to the sealing element 194. For example, the first end portion 202 includes one or more coils in contact with the valve element 194. The second end portion 204 is connected to the spacer portion 162 and/or plug portion 160. For example, the second end portion 204 includes one or more coils in contact with the one-way valve 206. The spring 200 has an initial, undeflected length that is longer than a distance 203 between the sealing element 194 and the one-way valve 206 such that the spring 200 is partially compressed and has a pre-load when the spring 200 is in the fill plug vent 114. The pre-load on the spring 200 causes the first and second end portions 202, 204 to firmly engage the seal element 194 and the one-way valve 206. Further, the preload on the spring 200 causes the spring 200 to resiliently bias the seal element 194 against the valve seat 196 and close the valve 180.

Regarding FIG. 5B, as the fill plug vent 114 rotates with the hub body 118 above a predetermined rotational velocity of the fill plug vent 114, the rotational motion of the fill plug vent 114 about the spindle 102 causes the sealing element 194 to shift along the central axis 215 away from the valve seat 196 against the biasing force of the spring 200. For example, the sealing element 194 may experience a phenomenon commonly referred to as a centrifugal force as the fill plug vent 114 rotates about the spindle 102 urging the sealing element 194 outward against the biasing force of the spring 200. The centrifugal force on the fill plug vent 114 increases as the rotational speed of the hub body 118 and fill plug vent 114 connected thereto increases. The spring constant of the spring 200 may be selected to provide a centripetal force that counteracts the centrifugal force on the sealing element 194 and maintains the sealing element 194 in the closed position against the valve seat 196 (which closes the valve 180) until the fill plug vent 114 rotates at or above a predetermined speed about the spindle 102. When the fill plug vent 114 rotates at or above the predetermined speed, the centrifugal force on the sealing element 194 overcomes the biasing force of the spring 200, causing the sealing element 194 to shift away from the valve seat 196 and reconfigure the valve 180 to the open configuration. The shifting of the sealing element 194 away from the valve seat 196 further compresses the spring 200 and increases the bias force the spring 200 applies to the sealing element 194 to urge the sealing element 194 back toward the valve seat 196.

The predetermined speed at which the valve 180 shifts to the open configuration may be a speed slightly above a speed at which the oil in the interior 117 spreads evenly along the interior surface 119 of the hub body 118 and forms the air pocket 188 as shown in FIG. 2A. For example, the predetermined speed at which the valve 180 shifts to the open configuration may be in the range of about 25 mph to about 35 mph. In this manner, the valve 180 shifts from the closed configuration (FIG. 5A) to the open configuration (FIG. 5B) after the inner air pocket 188 is formed to permit air to flow through the air inlet 174 if the fill plug vent 114 while the oil is spread along against the interior surface 119 of the hub body 118 and kept clear of the air inlet 174 by the rotation of the hub body 118. When the air pressure in the interior 117 of the hub body 118 increases above the ambient air pressure outside of the hub body 118, the pressure differential causes the higher pressure air in the interior 117 to enter the air inlet 174, travel along flow path 179 (see FIG. 5B), and exit the fill plug vent 114 at outlets 176.

When the rotational speed of the hub body 118 and fill plug vent 114 slows below the predetermined speed, the biasing force of the spring 200 overcomes the centrifugal force urging the sealing element 194 against the valve seat 196 and reconfigures the valve 180 from the open configuration to the closed configuration. Below the predetermined speed, the oil is not evenly held against the interior surface 119 of the hub body 118 such that the air inlet 174 may be submerged or otherwise travel through the oil in the interior 117 of the wheel hub 116. Thus, closing the valve 180 below the predetermined speed inhibits oil from escaping the wheel hub 116 through the fill plug vent 114.

Regarding FIG. 5A, the one-way valve 206 of the fill plug vent 114 permits fluid flow in a downstream direction from the air inlet 174 to the air outlets 176 and inhibits flow in an upstream direction from the air outlets 176 to the air inlet 174. The one-way valve 206 thus inhibits fluid and debris from outside of the wheel hub (e.g., water and dirt) from entering the wheel hub 116 through the fill plug vent 114. In one embodiment, the one-way valve 206 includes an elastomeric member having a vent portion 208. The vent portion 208 may include a dome-shaped portion 208A that bulges in the downstream direction. The dome-shaped portion 208A includes one or more slits (e.g., a straight slit or a plurality of intersecting slits) formed in the apex of the dome-shaped portion 208A. The dome-shaped portion 208A has internal stresses due to its shape that bias the slits closed. A positive pressure differential across the dome-shaped portion 208A, e.g., when the air pressure in the interior 117 of the hub body 118 is higher than ambient air pressure, causes the slits in the dome-shaped portion 208A to open. A negative or even pressure differential across the dome-shaped portion 208A is unable to open the slits of the dome-shaped portion 208A.

The one-way valve 206 includes a mounting portion such as a flange 210 to secure the one-way valve 206 in the fill plug vent 114. In one embodiment, the plug portion 160 has a step 218 between a small diameter portion 220 and a large diameter portion 222 of the axial portion 214 of the passageway 212. The flange 210 is secured between a surface 218A of the step 218 and an end portion 195 of the tube 182. The end portion 195 of the tube 182 may be secured to the body 166 of the plug portion 160 by, for example, welding or adhesive, which secures the one-way valve 206 to the body 166.

In operation, the wheel hub 116 may be rotated about the spindle 102, for instance, as the vehicle is driven. For example, the drive axle 104 may be rotated by a motor of the vehicle to cause the wheel hub 116, and a wheel mounted thereto, to rotate about the spindle 102 to move the vehicle. On non-driven axles, the wheel hubs 116 may be rotated by the wheel mounted thereto as the vehicle moves. As the speed of rotation of the wheel hub 116 increases, the lubricant in the hub body 118 spreads along the inner surface of the hub body 118 and forms the inner air pocket 188. When the wheel hub 116, and thus the fill plug vent 114, rotates at or above a predetermined speed, the valve 180 of the fill plug vent 114 opens due to the rotation to permit air to flow through fill plug vent 114 from the inner air pocket 188 in the interior of the hub body 118. The valve 180 may open due to the centrifugal force on a sealing portion of the valve 180 shifting the valve 180 from the closed configuration to the open configuration. For instance, the centrifugal force on the sealing element 194 may cause the sealing element 194 to shift away from the valve seat 196 against the biasing force of the spring 200 and open the valve. When the rotational speed of the wheel hub 116, and thus the fill plug vent 114, falls below the predetermined speed, the valve 180 of the fill plug vent 114 closes to inhibit air flow through the fill plug vent 114. For instance, the biasing force of the spring 200 on the sealing element 194 of the valve 180 may overcome the centrifugal force on the sealing element 194 due to rotation of the sealing element 194 to urge the sealing element 194 against the valve seat 196. The valve 180 may be shifted to the closed configuration when the rotational speed of the wheel hub 116 slows to inhibit lubricant from flowing through the fill plug vent 114, for example, when the inner air pocket 188 begins to break down as the lubricant begins to collect at the lower portion of the grease pocket 140.

While the vent for the wheel hub 116 has been described as being a part of the fill plug vent 114, in other forms, the vent may be mounted at other locations of the wheel hub assembly 100 to similarly vent air from the wheel hub 116 due to rotation of the vent with the wheel hub 116. For example, another opening may be formed in the hub body 118 and the vent secured in the opening. The vent may be permanently secured to the hub body 118, for example, by welding. As another example, the vent may be mounted to the outboard seal 152 with an air inlet in communication with the interior 117 of the hub body 118 and an air outlet in communication with the axle 104. Upon rotation of the outboard seal 152 with the hub body 118, a valve of the vent may open to permit air to flow from the interior 117 to the axle 104.

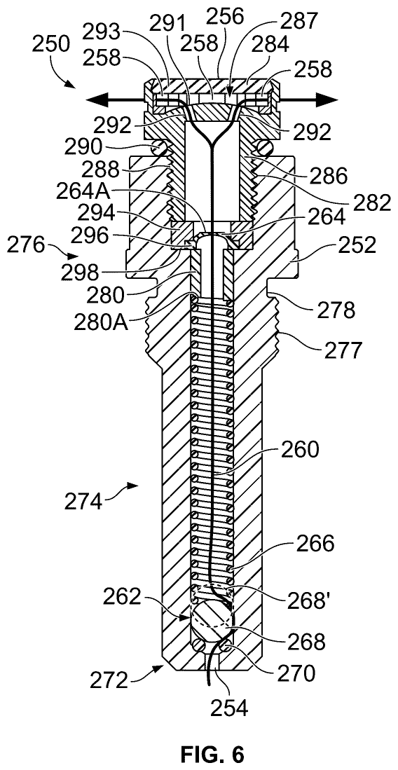

Regarding FIG. 6, a fill plug vent 250 is provided according to another embodiment. The fill plug vent 250 is similar in many respects to the fill plug vent 114 such that the differences will be highlighted. The fill plug vent 250 includes an outer body 252 and a vent portion 256, such as a breather cap, attached to the outer body 252. The vent portion 256 permits air to vent therethrough while inhibiting ingress of contaminants (e.g., moisture, dirt, grime) from entering the outer body 252. The outer body 252 has an air inlet 254 and the vent portion has air outlets 258. The outer body 252 and vent portion 256 form a flow path 260 for air from the air inlet 254 to the air outlets 258. The outer body 252 and vent portion 256 contain an inertia-controlled valve 262 and one-way valve 264 similar to the fill plug vent 114. For example, the inertia-controlled valve 262 includes a spring 266 that biases a sealing element 268 against a valve seat 270. Similar to the fill plug vent 114, rotational motion of the fill plug vent 250 (e.g., with rotation of the wheel hub to which the fill plug vent 250 is mounted) causes the sealing element 268 to shift away from the valve seat 270 (e.g., to position 268′) to permit air to flow into the air inlet 254, along the flow path 260, and out from the air outlets 258.

The outer body 252 has an inlet portion 272 including the air inlet 254, a spacer portion 274, and plug portion 276 formed as a single-piece. Forming the outer body 252 as a single-piece may simplify assembly of the fill plug vent 250 by reducing the number of components to be secured together. The single-piece outer body 252 also enables the fill plug vent 250 to be replaced as one unit. The inlet portion 272 may include a conical portion that tapers to an end of the outer body 252 with the air inlet 254. The outer body 252 include male threads 277 to engage female threads of a lubricant opening of a wheel hub. The outer body 252 includes an annular recess such as a groove 278 to receive a seal member, such as an O-ring, to inhibit fluid from leaking between the wheel hub and the fill plug vent 250.

The fill plug vent 250 includes a spring spacer 280 in the outer body 252 to limit movement of the spring 200. The axial position of an end 280A of the spring spacer 280 that contacts the spring 200 may be selected to compress the spring 200 to set a desired spring force that keeps the inertia-controlled valve 262 closed. For example, the axial length of the spring spacer 280 may be selected to position the end 280A of the spring spacer 280 at the desired axial position. The inertia-controlled valve 262 is normally closed due to the spring force and opens when this spring force is overcome, for example, due to force of the sealing element 268 against the spring 200 caused by rotation of the wheel hub at a certain vehicle speed. Adjusting the axial position of the spring spacer 280 adjusts the force required to open the inertia-controlled valve 262 and thereby adjusts the required vehicle speed at which the sealing element 268 overcomes the biasing force of the spring 200 to open the valve 262. As one example, the spring spacer 280, spring 200, and sealing element 268 are configured such that the sealing element 268 shifts away from the valve seat 270 when the vehicle is traveling at a speed of at least 25 miles per hour. Considerations to set the threshold vehicle speed to open include the spring constant, the weight of the sealing element 268, and the preload on the spring 200 when the inertia-controlled valve 262 is closed.

The plug portion 276 of the outer body 252 includes female threads 282 to engage male threads 288 of the vent portion 256. The vent portion 256 includes a head portion 284 and a shaft portion 286 extending from the head portion 284. The head portion 284 and shaft portion 286 include an internal compartment 287 that form a portion of the flow path 260. The head portion 284 includes a filter such as a thin membrane 291 that permits air to flow therethrough while inhibiting moisture and larger particles (e.g., dirt, grime) from flowing therethrough. For example, the membrane 291 permits air to flow along flow path 260 and inhibits moisture and other particles from flowing upstream of the membrane 291. The head portion 284 includes openings 292 upstream of the membrane 291 to permit air of wheel hub to flow to the membrane 291. The head portion 284 may include air outlets 258 through which air may vent from the fill plug vent 250 similar to air outlets 176 discussed above. The vent portion 256 includes a cap 293 secured to the head portion 284 to enclose the membrane 291 in the compartment 287. The outer surface of the shaft portion 286 includes male threads 288 to engage female threads 282 of the outer body 252 and connect the vent portion 256 to the outer body 252. A seal member such as an O-ring 290 is disposed between the head portion 284 of the vent portion 256 and the outer body 252 to provide a fluid tight seal therebetween.

The vent portion 256 may hold the one-way valve 264 in place in the flow path 260 when the vent portion 256 is threaded into the outer body 252. The fill plug vent 250 may include a valve spacer 294 that engages an outer flange 296 of the one-way valve 264 to secure the one-way valve 264 in the flow path 260. The shaft portion 286 of the vent portion 256 presses against the valve spacer 294 when threaded to the outer body 252 which urges the outer flange 296 of the one-way valve 264 against a shoulder 298 of the outer body 252 to secure the one-way valve 264 in the flow path. The outer flange 296 of the one-way valve 264 may also be clamped between the valve spacer 294 and the spring spacer 280. In one embodiment, the one-way valve 264 includes an elastomeric central portion 264A having a dome shape that bulges in the downstream direction. The central portion 264A has one or more slits formed in the apex of the dome-shaped central portion 264A. When the air pressure upstream of the one-way valve 264 exceeds as threshold, the one or more slits of the dome-shaped central portion 264A open to permit air to travel therethrough.

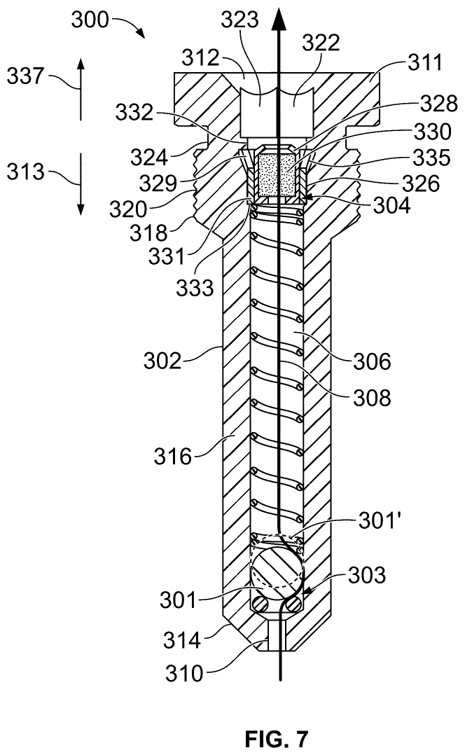

Regarding FIG. 7, a fill plug vent 300 is provided according to another embodiment. The fill plug vent 300 is similar in many respects to embodiments discussed above such that differences will be highlighted. The fill plug vent 300 includes an outer body 302, an inertia-controlled valve 303, and a filter assembly 304.

The outer body 302 includes a central passageway 306 defining a flow path 308 from an air inlet 310 to an air outlet 312. The outer body 302 has a unitary, one-piece construction and includes an inlet portion 314 including the air inlet 310, a spacer portion 316, and plug portion 318 including the air outlet 312. Forming the outer body 302 as a single piece may simplify assembly of the fill plug vent 300 by reducing the number of components to be secured together and also avoid potential interference with other wheel end components located near the plug portion. The inertia-controlled valve 303 is positioned in the flow path 308 to permit or inhibit fluid from entering the air inlet 310 and flowing along the flow path 308. Specifically, the inertial-controlled valve 303 includes a sealing element 301 that, when shifted to an open position 301′, permits air to travel along the flow path 308.

The plug portion 318 of the outer body 302 may include male threads 320 on an outer surface thereof to engage female threads of a lubricant fill opening of a wheel hub to secure the fill plug vent 300 to the wheel hub. The plug portion 318 may include an annular recess such as a groove 324 to receive a seal member, such as an O-ring, to form a fluid tight seal between the plug portion 318 and the wheel hub. The outer body 302 has a head portion 311 with a rotary drive structure 322 to receive a drive portion of a tool to rotate the fill plug vent 300 and connect or disconnect the fill plug vent 300 and the wheel hub. For example, the rotary drive structure 322 may be configured to engage a Torx driver or Allen wrench, as some examples. The rotary drive structure 322 includes a central opening 323 sized to permit the filter assembly 304 to be advanced in direction 313 into position in the central passageway 306.

The filter assembly 304 includes a housing 326, a sleeve 328, and a filter 330. The filter 330 may be a sintered bronze filter. For example, the filter 330 may be formed of bronze particles molded together with a pore size to permit the flow of small particles (e.g., air) therethrough, while inhibiting the flow of larger particles (e.g., moisture and debris) therethrough. The filter 330 is in the sleeve 328. The filter 330 may be pressed into the sleeve 328 to secure the filter 330 in the sleeve 328. In one approach, the sleeve 328 is made of a heat shrink material. The filter 330 is pressed into the sleeve 328 and heat is applied to the sleeve 328 to cause the sleeve 328 to shrink about the filter 330 to secure the filter 330 in the sleeve 328. The sleeve 328 may be permanently mounted in the outer housing 326. For example, the sleeve 328 may be press fit into the outer housing 326 to secure the sleeve 328 and the filter 330.

Regarding FIG. 7, the filter assembly 304 may be permanently mounted in the outer body 302. For example, the filter assembly 304 may be advanced in direction 313 into the outer body 302 to secure the filter assembly 304 to the outer body 302 in the central passageway 306. The outer housing 326 may include barbs 329 configured to deflect together as the filter assembly 304 is advanced in direction 313 into the central passageway 306. The filter assembly 304 is advanced in direction 313 until the filter assembly 304 is at a desired depth in the central passageway 306, such as when a leading end 331 of the filter assembly 304 engages a seat 333 of the central passageway 306.

As the filter assembly 304 is advanced in direction 313 along the central passageway 306, the barbs 329 travel beyond an upper stop, such as a collar 332, and reach an undercut or recess 335 below the collar 332. The barbs 329 are able to expand apart in the recess 335 once the filter assembly 304 has been seated against the seat 333 in the central passageway 306. The expanded barbs 329 inhibit movement of the filter assembly 304 in direction 337 out of the central passageway 306. The barbs 329 may include, for example, deflectable wings that can resiliently deflect together and apart as the filter assembly 304 is installed in the central passageway 306.

In one aspect of the present disclosure, a wheel hub assembly is provided that includes a wheel hub body, bearing assemblies, and a vent. The wheel hub body has an interior and the bearing assemblies rotatably couple the wheel hub body to a spindle of a vehicle. The vent is connectable to the wheel hub body to permit air to flow from the interior of the wheel hub body to an exterior of the wheel hub body. For example, the vent may include an air inlet to be in fluid communication with the interior and an air outlet outside of the interior to permit air to flow out of the wheel hub. The vent includes a valve that has sealing portions biased into engagement to inhibit air flow through the vent. The sealing portions shift apart to permit air flow through the valve in response to rotational motion of the sealing portions with the wheel hub body about the spindle. For instance, a centrifugal force on the sealing portions due to their rotation with the wheel hub body causes one or more of the sealing portions to shift from a closed position thereof which permits air to flow through the valve. The one or more sealing portions may shift away from the closed position thereof when the wheel hub body rotates at or above a predetermined speed, for example, a speed at which the lubricant in the wheel hub body is spread along an interior of the wheel hub body and forms an inner air pocket radially inward of the lubricant. The air inlet of the vent may be positioned in the region of the wheel hub body where the inner air pocket is formed such that the valve inhibits air flow through the valve until the inner air pocket is formed about the air inlet of the valve to inhibit lubricant from flowing through the vent. The vent enables the air pressure in the interior of the wheel hub body to be regulated by permitting air to escape from the interior of the wheel hub, for example, as the air pressure in the wheel hub increases due to an increase in air temperature and/or a seal pumping air into the interior.

In one aspect of the present disclosure, a fill plug vent is provided for a wheel hub. The fill plug vent includes a plug portion to close a lubricant opening in a wall of a wheel hub. For example, the plug portion may be inserted into the lubricant opening of the wheel hub to mount the fill plug vent to the wheel hub. The plug portion of the fill plug vent includes an air outlet. The fill plug vent includes a spacer portion extending from the plug portion and supporting an air inlet of the fill plug vent away from the plug portion. The spacer portion may support the air inlet in an interior of the wheel hub, radially inward of the wall of the wheel hub, in the region of the wheel hub where the inner air pocket is formed upon rotation of the wheel hub. The fill plug vent includes a valve having a closed configuration that inhibits air from flowing from the air inlet to the air outlet and an open configuration that permits air to flow from the air inlet to the air outlet. The valve is configured to shift from the closed configuration to the open configuration in response to the fill plug vent rotating with the wheel hub.

The present disclosure also provides a method of venting an interior of a wheel hub, where the wheel hub has a vent to permit air to flow outward from the interior of the wheel hub. The method includes rotating the wheel hub about a spindle and opening a valve of the vent in response to rotation of the wheel hub about the spindle to permit air to flow from the lubricant cavity. The valve may be opened in response to rotation of the vent at or above a predetermined speed, for example, the speed at which the inner air pocket is formed in the wheel hub.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims. For example, the length of the spacer portion and/or the angle at which the spacer portion protrudes into the interior of the wheel hub may be selected according to the geometry and oil fill level of a given wheel hub.

What is claimed is:

1. A wheel hub assembly for a vehicle, the wheel hub assembly comprising:
a wheel hub body having an interior;
bearing assemblies to rotatably connect the wheel hub body to a spindle of the vehicle;
a vent associated with the wheel hub body that opens to the interior of the wheel hub body; and
an inertia-controlled valve of the vent rotatable with the wheel hub body, the inertia-controlled valve configured to open in response to rotation of the inertia-controlled valve with the wheel hub body and permit air to flow out of the interior of the wheel hub body.

2. The wheel hub assembly of claim 1 wherein the inertia-controlled valve is configured to open in response to the inertia-controlled valve rotating with the wheel hub body at or above a predetermined valve opening speed.

3. The wheel hub assembly of claim 2 wherein the inertia-controlled valve is configured to close in response to the inertia-controlled valve rotating with the wheel hub body at a speed less than the valve opening speed.

4. The wheel hub assembly of claim 1 wherein the inertia-controlled valve is configured to open in response to rotation of the inertia-controlled valve with the wheel hub body at a speed that corresponds to a vehicle speed of at least 10 miles per hour.

5. The wheel hub assembly of claim 1 wherein the inertia-controlled valve comprises a sealing element and a valve seat, the sealing element shifting away from the valve seat in response to the rotation of the inertia-controlled valve with the wheel hub body.

6. The wheel hub assembly of claim 1 wherein the inertia-controlled valve comprises a sealing element, a valve seat, and a spring biasing the sealing element into engagement with the valve seat; and
wherein the sealing element is operable to deflect the spring and shift away from the valve seat in response to rotation of the inertia-controlled valve with the wheel hub body.

7. The wheel hub assembly of claim 1 wherein the wheel hub body has a side wall with an interior surface defining at least a portion of the interior, an exterior surface opposite the interior surface, and a through opening extending from the interior surface to the exterior surface; and
wherein the open inertia-controlled valve permits air to travel through the through opening of the side wall of the wheel hub body via the vent.

8. The wheel hub assembly of claim 1 wherein the wheel hub body includes a lubricant fill opening; and
wherein the vent includes a plug portion configured to be releasably connected to the wheel hub body and close the lubricant fill opening.

9. The wheel hub assembly of claim 1 wherein the wheel hub body includes an interior surface defining at least a portion of the interior of the wheel hub body;
wherein the vent includes an air inlet; and
wherein the vent includes a spacer portion that spaces the air inlet away from the interior surface of the wheel hub body to inhibit lubricant in the interior from flowing out of the interior of the wheel hub body upon opening of the inertia-controlled valve.

10. The wheel hub assembly of claim 1 wherein the vent includes a one-way valve to inhibit ingress of moisture into the interior of the wheel hub body.

11. The wheel hub assembly of claim 1 wherein the vent includes a filter to permit flow of air therethrough and to inhibit ingress of moisture into the interior of the wheel hub body.

12. The wheel hub assembly of claim 1 wherein the inertia-controlled valve is configured to close in response to the inertia-controlled valve being stationary.

13. An air vent for a wheel hub, the air vent comprising:
a plug portion to close an opening in a wall of the wheel hub;
an air outlet of the plug portion;
an air inlet;
a spacer portion extending from the plug portion and supporting the air inlet spaced from the plug portion;
a valve having a closed configuration that inhibits air from flowing from the air inlet to the air outlet and an open configuration that permits air to flow from the air inlet to the air outlet; and
the valve configured to shift from the closed configuration to the open configuration in response to the air vent rotating with the wheel hub.

14. The air vent of claim 13 wherein the valve is configured to shift from the closed configuration to the open configuration upon the wheel hub rotating at or above a predetermined speed.

15. The air vent of claim 13 wherein the valve includes a biasing member urging the valve to the closed configuration.

16. The air vent of claim 13 wherein the valve includes a sealing element and a valve seat, the sealing element engaging the seat in the closed configuration of the valve and spaced from the valve seat in the open configuration of the valve.

17. The air vent of claim 16 wherein the valve includes a spring that resiliently biases the sealing element against the valve seat.

18. The air vent of claim 16 wherein the sealing element includes a ball bearing and the valve includes a spring that urges the ball bearing against the valve seat.

19. The air vent of claim 13 wherein the spacer portion is configured to space the air inlet from the wall when the plug portion closes the opening of the wall of the wheel hub.

20. The air vent of claim 13 wherein the plug portion includes threads to engage threads of the wall of the wheel hub.

21. The air vent of claim 13 further comprising a one-way valve between the air inlet and air outlet to inhibit fluid flow from the air outlet to the air inlet.

22. The air vent of claim 13 further comprising a filter to permit flow of air therethrough and to inhibit flow of moisture from the air outlet to the air inlet.

23. The air vent of claim 22 wherein the filter includes a housing including a least one barb securing the filter in the plug portion between the air inlet and the air outlet.

24. The air vent of claim 13 wherein the plug portion, air inlet, and spacer portion have a unitary, one-piece construction.

25. A method of relieving air pressure in an interior of a wheel hub of a wheel hub assembly, the wheel hub assembly including an air vent rotatable with the wheel hub, the method comprising:
rotating the wheel hub and air vent; and
opening a valve of the air vent in response to rotation of the air vent with the wheel hub to vent air in the interior of the wheel hub to ambient air.

26. The method of claim 25 wherein opening the valve in response to rotation of the air vent includes opening the valve when the air vent rotates at or above a predetermined speed.

27. The method of claim 26 further comprising closing the valve when the air vent rotates below the predetermined speed.

28. The method of claim 25 wherein opening the valve in response to rotation of the air vent includes moving a sealing element of the valve away from a valve seat of the valve and against a bias force of a spring of the valve.

29. The method of claim 25 wherein the wheel hub includes a side wall having an interior surface defining at least a portion of the interior of the wheel hub, an exterior surface opposite the interior surface, and a port extending between the interior and exterior surfaces of the wheel hub; and
wherein opening the valve of the air vent comprises permitting air to flow from the interior of the wheel hub, through the port, and into the ambient air via the air vent.
